(19) United States
(12) Patent Application Publication
(10) Pub. No.: US 2021/0221178 A1
(43) Pub. Date: Jul. 22, 2021

(54) MOTORCYCLE TIRE

(71) Applicant: BRIDGESTONE CORPORATION, Tokyo (JP)

(72) Inventors: Takamitsu NAKAMURA, Tokyo (JP); Yasufumi TOKITOH, Tokyo (JP); Naoki SHIMAMURA, Tokyo (JP)

(73) Assignee: BRIDGESTONE CORPORATION, Tokyo (JP)

(21) Appl. No.: 16/755,296

(22) PCT Filed: Aug. 30, 2018
(86) PCT No.: PCT/JP2018/032215

§ 371 Date: Apr. 10, 2020

(30) Foreign Application Priority Data
Oct. 11, 2017 (JP) 2017-197973

(51) Int. Cl. B60C 11/03

(52) U.S. Cl. CPC B60C 11/0304; B60C 2011/0372; B60C 2011/0362; B60C 2200/10

(57) ABSTRACT

Provided is a motorcycle tire with improved wet grip performance while ensuring the rigidity during turning. Provided is a motorcycle tire in which: a tread portion is composed of a central rubber (11C) and a both-side rubber (11S) having a lower modulus than the central rubber; the boundary is from the tire equator to from ½ to ¾ of the half width of the peripheral length; a tire grounding portion includes a first groove, a second groove, and a third groove; a bent portion of the first groove and a bent portion of the second groove, an inner side end and an outer side end in the width direction of the second groove, an inner side end in the width direction of the third groove are located at positions from ⅛ to ⅜, from ¼ to ½, from 1/16 to 3/16, from ⅝ to ⅞, and from ½ to ⅝ of the half width of the peripheral length from the tire equator; the angles θ1, θ2, θ3, θ4, and θ5 formed by a long groove portion and a short groove portion of the first groove, an outer side groove portion and an inner side groove portion of the second groove, and the third groove with respect to the circumferential direction satisfy θ1≈θ2≈θ3≈θ5, and θ1>θ4; and a distance a between the first groove and the second groove, a distance b between the second groove and the third groove, and a distance c between the third groove and the first groove satisfy a≈b≈c.

### TECHNICAL FIELD

The present invention relates to a motorcycle tire (hereinafter, also simply referred to as a “tire”), and more particularly, to a motorcycle tire including an improved tread portion, and particularly to a motorcycle front tire.

### BACKGROUND ART

A motorcycle tire has a shape with a round cross-section in which the tire crown has a smaller radius of curvature than those for four-wheeled vehicle tires, due to characteristics of a two-wheeled vehicle that turns while leaning the body unlike four-wheeled vehicles such as passenger cars, trucks, or buses. In other words, in a motorcycle pneumatic tire, when a motorcycle is traveling straight, the center of a tread mainly contacts the ground, and when turning, a shoulder portion of the tread contacts the ground.

In view of such characteristics of motorcycle tires, examples of a method for ensuring grip performance of a motorcycle tire when turning include a technique of arranging a low-hardness rubber compound on a shoulder portion of a tread used during turning. On the other hand, in order to improve the drainage of a motorcycle tire, it is advantageous to provide a lateral groove extending in the tire width direction across the tire equator on an entire tread grounding portion, and further provide a plurality of other lateral grooves to have a structure in which water is discharged from a tread end (see, for example, Patent Document 1).

### RELATED ART DOCUMENT

### Patent Document

Patent Document 1 JP2013-163446 A (Claims and the like)

### SUMMARY OF THE INVENTION

### Problems to be Solved by the Invention

In order to improve the grip performance of a motorcycle tire when turning on a wet road surface such as when it is raining, it is conceivable to incorporate both of the above-described two techniques. However, in this case, there is a problem that the rigidity of a shoulder portion of the tread is reduced, the rigidity in the tire straight traveling direction at the time of turning is not sufficiently secured, and the steering stability is deteriorated.

Accordingly, an object of the present invention is to provide a motorcycle tire that maintains the rigidity during turning and ensures favorable steering stability while further improving the wet grip performance during turning.

### Means for Solving the Problems

As a result of intensive studies, the present inventors have found that the above-described problems can be solved by defining arrangement conditions of tread rubbers and grooves in a predetermined manner, thereby completing the present invention.

Specifically, the present invention provides a motorcycle tire including a directional pattern in which a rotation direction when mounted on a vehicle is specified on a tire grounding portion, wherein

a tread portion forming the tire grounding portion is composed of a central rubber arranged across a tire equator and a both-side rubber arranged outside the central rubber in a tire width direction and having a lower modulus than the central rubber, and a boundary between the central rubber and the both-side rubber is in a range of from ½ to ¾ of a half width of a peripheral length from the tire equator,

on the tire grounding portion, a first groove that includes a bent portion and extends across the tire equator, and whose both ends in the tire width direction are open to tread ends, a second groove that includes a bent portion and whose both ends in the tire width direction terminated in one side surface in the tire width direction, and a third groove whose outer side end in the tire width direction opens to the tread end and whose inner side end in the tire width direction terminates on one side surface in the tire width direction are sequentially provided in a direction opposite to a tire rotation direction,

the first groove extends in the tire rotation direction in an inclined manner so as to be substantially line-symmetric in the tire width direction about the bent portion, and the bent portion of the first groove is in a range of from ⅛ to ⅜ of the half width of the peripheral length from the tire equator,

the bent portion of the second groove is in a range of from ¼ to ½ of the half width of the peripheral length from the tire equator, the inner side end in the tire width direction of the second groove is in a range of from 1/16 to 3/16 of the half width of the peripheral length from the tire equator, and the outer side end in the tire width direction of the second groove is in a range of from ⅝ to ⅞ of the half width of the peripheral length from the tire equator,

the inner side end in the tire width direction of the third groove is in a range of from ½ to ⅝ of the half width of the peripheral length from the tire equator,

when two groove portions extending in an inclined manner so as to be line-symmetric in the tire width direction of the first groove are defined as a long groove portion extending across the tire equator and a short groove portion extending in one side surface in the tire width direction, and acute angles of angles formed by the long groove portion and the short groove portion with respect to the tire circumferential direction are defined as θ1 and θ2, respectively, when, with the bent portion interposed, a groove portion on the outer side in the tire width direction of the second groove is defined as an outer side groove portion and a groove portion on the inner side in the tire width direction of the second groove is defined as an inner side groove portion, and acute angles of angles formed by the outer side groove portion and the inner side groove portion with respect to the tire circumferential direction are defined as θ3 and θ4, respectively, and when the acute angle of the angles formed by the third groove with respect to the tire circumferential direction is defined as θ5, θ1≈θ2≈θ3≈θ5, and θ1>θ4 are satisfied, and, distances a, b, and c between the grooves in the tire circumferential direction measured between the open ends of the tire grounding portions of the first groove and the second groove, the second groove and the third groove, and the third groove and the first groove satisfy a≈b≈c.

In the tire of the present invention, it is preferable that the angle θ1 of the long groove portion of the first groove is in a range of from 45° to 55°, and the angle θ2 of the short groove portion of the first groove is in a range of from 45° to 55°. In the tire of the present invention, it is preferable that the angle θ3 of the outer side groove portion of the second groove is in a range of from 45° to 55°, and the angle θ4 of the inner side groove portion of the second groove is in a range of from 15° to 25°. Further, in the tire of the present invention, it is preferable that the angle θ5 of the third groove is in a range of from 45° to 55, and it is also preferable that a shallow groove is arranged near the third groove.

Here, in the present invention, the half width P/2 of the peripheral length means ½ of a tire width direction distance P between both tread ends TEs measured along the tread surface in an unloaded state with a tire mounted on an applicable rim and filled to a specified internal pressure. Herein, the “applicable rim” means a rim specified by an industrial standard valid in a region where a tire is produced and used, and “specified internal pressure” means air pressure corresponding to the maximum load capacity in an application size described in this industrial standard. The industrial standards are JATMA YEAR BOOK of Japan Automobile Tire Association (JATMA) in Japan, STANDARDS MANUAL of The European Tyre and Rim Technical Organisation (ETRTO) in Europe. YEAR BOOK of The Tire and Rim Association, Inc. (TRA) in the United States, and the like.

### Effects of the Invention

According to the present invention, a motorcycle tire that maintains the rigidity during turning and ensures favorable steering stability while further improving the wet grip performance during turning can be provided.

### BRIEF DESCRIPTION OF THE DRAWINGS

FIG. 1 is a sectional view in the width direction showing an example of a motorcycle tire according to the present invention.

FIG. 2 is a partial development view showing a tread pattern of an example of a motorcycle tire of the present invention.

### MODE FOR CARRYING OUT THE INVENTION

Hereinafter, embodiments of the present invention will be described in detail with reference to the drawings.

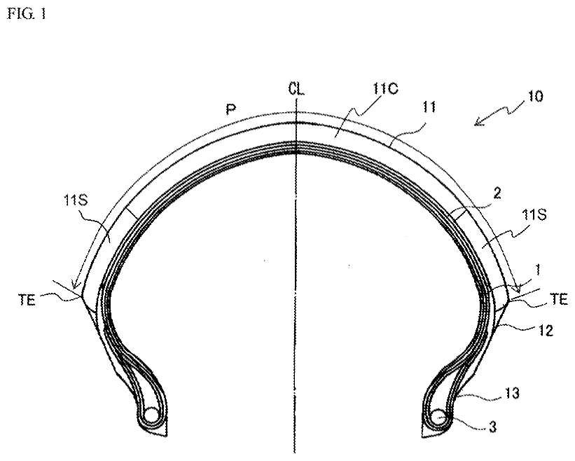

FIG. 1 is a sectional view of the width direction showing an example of the motorcycle tire according to the present invention. The illustrated tire 10 of the present invention includes a tread portion 11 forming a grounding portion, a pair of sidewall portions 12 extending inward in the tire radial direction continuously from both sides of the tread portion, and a pair of bead portions 13 that are each continuous with the inner peripheral side of each of the sidewall portions 12. The tread portion 11, the sidewall portion 12, and the bead portion 13 are reinforced by at least one, for example, one or two carcass plies 1 toroidally extending between a pair of the bead portions 13, and at least one, for example, one or two belt layers 2 are arranged outside the carcass ply 1 in the tire radial direction.

As shown in FIG. 1, in the motorcycle tire 10 of the present invention, the tread portion 11 forming the tire grounding portion includes: a central rubber 11C arranged across a tire equator CL: and a both-side rubber 11S arranged on an outer side in the tire width direction of the central rubber 11C and having a lower modulus than the central rubber 11C. Specifically, in the motorcycle tire 10 of the present invention, since the center side of the tire grounding portion is made of the central rubber 11C having a relatively high modulus, and the shoulder side is made of the both-side rubber 11S having a relatively low modulus, both the wear resistance during straight traveling and the grip performance during turning can be achieved.

In the present invention, a boundary between the central rubber 11C and the both-side rubber 11S is in a range of from ½ to ¾ of the half width P/2 of the peripheral length from the tire equator CL, and particularly in a range of from 9/16 to 11/16. When the area in which the central rubber 11C is provided is too wide, the grip performance during turning is not sufficiently obtained, and when the area in which the both-side rubbers 11S are provided is too wide, the wear resistance deteriorates.

Here, in the present invention, regarding the central rubber 11C and the both-side rubber 11S, the modulus is not specifically limited as long as the central rubber 11C has a relatively high modulus and the both-side rubber 11S has a relatively low modulus, and the modulus can be appropriately selected within a range usually used for a tread rubber of a tire. For example, regarding the specific modulus of the rubber composition constituting each rubber, using a 300% modulus at 100° C., the 300% modulus M₃₀₀(C) of the central rubber 11C is in a range of from 7 MPa to 13 MPa, and the 300% modulus M₃₀₀(S) of the both-side rubber 11S is in a range of from 6 MPa to 10 MPa, and M₃₀₀(C)>M₃₀₀(S) is satisfied. By setting the 300% modulus of the central rubber 11C to the above-described range, a favorable wear resistance can be obtained, and by setting the 300% modulus of the both-side rubber 11S to the above-described range, a favorable grip performance during turning can be obtained.

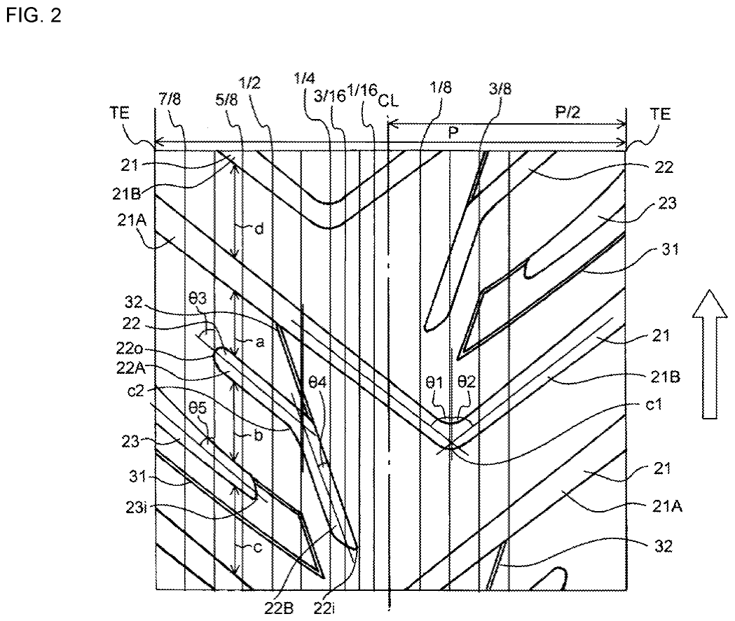

FIG. 2 is a partial development view showing an example of a tread pattern of a motorcycle tire of the present invention. As illustrated, the motorcycle tire of the present invention includes, on the tire grounding portion, a directional pattern specifying a rotation direction when the tire is mounted on a vehicle. The arrow in the figure indicates the rotation direction of the tire.

As illustrated, in the motorcycle tire of the present invention, on the tire grounding portion, a first groove 21 that extends across the tire equator CL and opens at both ends in the tire width direction at the tread ends TE, a second groove 22 whose both ends in the tire width direction terminate in one side surface in the tire width direction, and a third groove 23 whose outer side end in the tire width direction is open at the tread end TE and whose inner side end in the tire width direction terminates in one side surface in the tire width direction are sequentially included in a direction opposite to the tire rotation direction.

As illustrated, in the present invention, a groove group including the first groove 21, the second groove 22, and the third groove 23 as a set is substantially repeatedly arranged symmetrically with respect to the tire equator CL and shifted in the tire circumferential direction by ½ an arrangement pitch. Here, in the present invention, the arrangement pitch of a pattern means one unit of repetition of a pattern formed by a groove provided in a tire tread in the tire circumferential direction. The arrangement pitch of each groove in the present invention is not particularly limited, and may be, for example, about from 1/9 to 1/16 of the entire circumference of a tire.

The first groove 21 includes a bent portion c1, and extends in the tire rotation direction in an inclined manner so as to be substantially line-symmetric with respect to the tire width direction about the bent portion c1, and the both-end portion in the tire width direction of the first groove 21 is open at the tread end TE. The bent portion c1 of the first groove 21 is in a range of from ⅛ to ⅜ of the half width P/2 of the peripheral length from the tire equator CL. Here, in the present invention, when two groove portions of the first groove 21 that extend in such a manner to be line-symmetric in the tire width direction are defined as a long groove portion 21A extending across tire equator CL and a short groove portion 21B extending in one side surface in the tire width direction, the position of the bent portion c1 is defined as the position of the intersection of a straight line passing through the center of the groove width of the long groove 21A and a straight line passing through the center of the groove width of the short groove 21B.

In the present invention, since the first groove 21 extends across the tire equator CL and opens to the tread end TE on both sides in the tire width direction, a water film on a tire grounding portion can be efficiently drained outward in the tire width direction. Since the bent portion c1 of the first groove 21 is located at a position distant from the tire equator CL, the rigidity during straight traveling can be ensured.

The second groove 22 includes a bent portion c2 and extends in the tire rotation direction from the tire equator CL side to the tread end TE side without crossing the tire equator CL, and both ends 22i and 22o of the second groove in the tire width direction terminate in one side surface in the tire width direction. The bent portion c2 of the second groove 22 is in a range of from ¼ to ½ of the half width P/2 of the peripheral length from the tire equator CL. Further, the inner side end 22i in the tire width direction of the second groove 22 is in a range of from 1/16 to 3/16 of the half width P/2 of the peripheral length from the tire equator CL, and the outer side end 22o in the tire width direction of the second groove 22 is in a range of from ⅝ to ⅞ of the half width P/2 of the peripheral length from the tire equator CL. Here, in the present invention, when a groove portion on the outer side in the tire width direction and a groove portion on the inner side in the tire width direction with the bent portion c2 therebetween of the second groove 22 are defined as an outer side groove portion 22A and an inner side groove portion 22B, respectively, the position of the bent portion c2 is defined as the position of the intersection of a straight line passing through the center of the groove width of the outer side groove portion 22A and a straight line passing through the center of the groove width of the inner side groove portion 22B.

In the present invention, by positioning the inner side end 22i of the second groove 22 in the tire width direction in the above-described range, the rigidity during straight traveling can be ensured, and by positioning the bent portion c2 in the above-described range, the rigidity during straight traveling can also be ensured since the bent portion c2 of the second groove 22 is prevented from overlapping with the bent portion c1 of the first groove 21 when viewed from the tire circumferential direction. Further, by positioning the outer side end 22o in the tire width direction in the above-described range, rigidity during turning can be ensured.

The third groove 23 extends in the tire rotation direction from the tire equator CL side to the tread end TE side without crossing the tire equator CL, and the outer side end in the tire width direction opens to the tread end TE, and an inner side end 23i in the tire width direction terminates on one side surface in the tire width direction. The inner side end 23i in the tire width direction of the third groove 23 is in a range of from ½ to ⅝ of the half width P/2 of the peripheral length from the tire equator CL.

In the present invention, by positioning the inner side end 23i of the third groove 23 in the tire width direction in the above-described range, the rigidity balance of the tread portion on the shoulder side can be improved, and the rigidity during turning can be ensured. When the third groove 23 is arranged in a region extending from the central rubber 11C to the both-side rubber 11S, an effect of reducing the rigidity of the arrangement region of the central rubber 11C can be obtained, which is preferable.

In the present invention, when acute angles formed by the long groove portion 21A and the short groove portion 21B of the first groove 21 with respect to the tire circumferential direction are defined as θ1 and θ2, respectively, acute angles of the outer side groove portion 22A and the inner side groove portion 22B of the second groove 22 with respect to the tire circumferential direction are defined as θ3 and θ4, respectively, and acute angle formed by the third groove 23 with respect to the tire circumferential direction is defined as θ5, these angles θ1, θ2, θ3, θ4, and θ5 satisfy θ1≈θ2≈θ3≈θ5, and θ1>θ4. Here, in the present invention, the angle formed by each groove portion or groove with respect to the tire circumferential direction is defined as the angle formed by a straight line passing through the center of the groove width of each groove portion or groove with respect to the tire circumferential direction.

In other words, in the present invention, the angle θ1 formed by the long groove portion 21A of the first groove 21 with respect to the tire circumferential direction, the angle θ3 formed by the outer side groove portion 22A of the second groove 22 with respect to the tire circumferential direction, the angle θ5 formed by the third groove 23 with respect to the tire circumferential direction, and the angle θ2 formed by the short groove portion 21B of the first groove 21 with respect to the tire circumferential direction are substantially the same. This means that the long groove portion 21A of the first groove 21, the outer side groove portion 22A of the second groove 22. the third groove 23, and the short groove portion 21B of the first groove 21 are arranged substantially in parallel. By making the long groove portion 21A of the first groove 21, the outer side groove portion 22A of the second groove 22, the third groove 23, and the short groove portion 21B of the first groove 21 substantially parallel to each other in such a manner, even when a plurality of grooves are arranged on the shoulder side where the low-modulus both-side rubber 11S is present, the rigidity is not compromised. By making the angle θ4 formed by the inner side groove portion 22B of the second groove 22 with respect to the tire circumferential direction smaller than the angle θ1 formed by the long groove portion 21A of the first groove 21 with respect to the tire circumferential direction, since the inner side groove portion 22B of the second groove 22 is on the center side, the rigidity during straight traveling can be ensured.

Here, that the angles θ1, θ2, θ3, and θ5 are substantially the same means that a manufacturing error is included. For example, the angles are substantially the same within an error range of ±10/a.

In the present invention, a distance a between the first groove 21 and the second groove 22, a distance b between the second groove 22 and the third groove 23, and a distance c between the third groove 23 and the first groove 21 in the tire circumferential direction measured between the open ends of the tire grounding portion satisfy a≈b≈c. By arranging the first groove 21, the second groove 22, and the third groove 23 at substantially equal intervals in such a manner, the rigidity during turning can be ensured. Here, the groove distance a between the first groove 21 and the second groove 22 substantially means the distance between the long groove portion 21A of the first groove 21 and the outer groove portion 22A of the second groove 22, the distance b between the second groove 22 and the third groove 23 substantially means the distance between the outer side groove portion 22A of the second groove 22 and the third groove 23, and the distance c between the third groove 23 and the first groove 21 substantially means the distance between the third groove 23 and the short groove portion 21B of the first groove 21. In the present invention, since each groove is arranged symmetrically with respect to the tire equator CL and shifted by ½ of the arrangement pitch, as illustrated, the long groove portion 21A of the first groove 21 and the other short groove portion 21B of the first groove 21 arranged symmetrically with each other are arranged adjacent to each other in the tire circumferential direction, and preferably, a distance d between the long groove portion 21A and the short groove portion 21B also satisfies a≈b≈c≈d. As a result, the rigidity during turning in the tire circumferential direction is more uniformly ensured, which is preferable.

Here, the distances a, b, c, and d, can be measured, for example, at the same position in the tire width direction where the first groove 21, the second groove 22, and the third groove 23 are arranged in such a manner to overlap when viewed in the tire circumferential direction. The fact that the distances a, b, c, and d between the grooves are substantially the same means that a manufacturing error is included. For example, when the distance is within an error range of ±20% on a mm basis, the distances are substantially the same.

As described above, in the present invention, by arranging the central rubber 11C and the both-side rubber 11S having a relatively low modulus on the tread portion under predetermined conditions and arranging the first groove 21, the second groove 22, and the third groove 23 under predetermined conditions, a motorcycle tire maintaining rigidity and wear resistance during straight traveling, ensuring favorable steering stability by maintaining rigidity during turning, and also having improved wet grip performance during turning was realized.

In the present invention, regarding the angle formed by each groove portion or groove with respect to the tire circumferential direction, specifically, the angle θ1 of the long groove portion 21A of the first groove 21 is preferably 45° or more, and more preferably 47° or more, and preferably 55° or less, and more preferably 52° or less, and the angle θ2 of the short groove portion 21B of the first groove 21 is preferably 45° or more, and more preferably 47° or more, and preferably 55° or less, and more preferably 520 or less. By setting the angle of each groove portion within the above-described range, water can be quickly drained in the tire width direction, which is preferable. When the above-described angle is less than 45° it is difficult to drain water from the shoulder side, and when the angle more than 55°, it is difficult to take in water from the center side, and neither of which is preferable.

The angle θ3 of the outer side groove portion 22A of the second groove 22 is preferably 45° or more, and more preferably 47° or more, and preferably 55° or less, and more preferably 52 or less, and the angle θ4 of the inner groove portion 22B of the second groove 22 is 15° or more, and more preferably 18° or more, and preferably 25° or less, and more preferably 22° or less. By setting the angle of each groove portion within the above-described range, water can be quickly drained in the tire width direction, and the rigidity in the straight traveling direction and the rigidity in the lateral direction can be balanced, which is preferable.

Further, the angle θ5 of the third groove 23 is preferably 45° or more, and more preferably 47° or more, and preferably 55° or less, and more preferably 52° or less. By setting the angle θ5 of the third groove 23 within the above-described range, water can be quickly drained in the tire width direction, and the rigidity in the straight traveling direction and the rigidity in the lateral direction can be balanced, which is preferable.

In the present invention, the groove width of the first groove 21, the second groove 22, and the third groove 23 can be, for example, in a range of from 5 mm to 10 mm. Here, the groove width of each groove means a width on a tread surface measured in a direction perpendicular to the extending direction of the groove. As illustrated, the groove width of each groove may vary along the direction in which the groove extends. The groove depth of the first groove 21, the second groove 22, and the third groove 23 can be, for example, from 2 mm to 5 mm.

In the present invention, in addition to the first groove 21, the second groove 22, and the third groove 23, a shallow groove 31 can be arranged near the third groove 23. The shallow groove 31 is composed of a portion extending from the inner side end 23i in the tire width direction of the third groove 23 on the extension of the third groove 23, a portion extending in parallel with the third groove 23 on the side opposite to the tire rotation direction of the third groove 23, and a portion that connects these two portions, and is provided in such a manner to surround the third groove 23. Here, in the present invention, the shallow groove means a groove with a narrow groove width and a shallow groove depth, such that the maximum groove width is 0.1 mm or more, and preferably 0.5 mm or more, and 2.0 mm or less, and preferably 1.5 mm or less and the maximum groove depth is 0.1 mm or more, and preferably 0.2 mm or more, and 2.0 mm or less, and preferably 0.5 mm or less. By providing a shallow groove having a groove width and a groove depth in the above-described ranges on a tire grounding portion, drainage at an early stage of use of a tire can be improved, which is preferable. In the illustrated example, also near the second groove 22, a shallow groove 32 extending toward the long groove portion 21A of the first groove 21 on the extension of the inner side groove portion 22B of the second groove 22 is arranged.

In the tire of the present invention, it is important that arrangement conditions of a central rubber and a both-side rubber constituting a tread rubber, and arrangement conditions of a groove provided on a tire grounding portion were defined as described above, and as a result, a desired effect can be obtained. Other details of the tire structure and the materials used are not particularly limited, and may be configured as follows, for example.

The carcass ply 1 is composed of a layer in which a reinforcing cord is covered with rubber, and it is necessary to arrange at least one carcass ply, and two or more carcass plies may be arranged. For example, one to three carcass plies can be arranged. The angle of a reinforcing cord of the carcass ply 1 is from 0 to 25° with respect to the tire width direction in the case of a radial tire, and is from 40 to 70 with respect to the tire width direction in the case of a bias tire. As a reinforcing cord of the carcass ply, an organic fiber cord such as polyester such as aliphatic polyamide (nylon), aromatic polyamide (aramid), rayon, polyethylene naphthalate (PEN), or polyethylene terephthalate (PET) is usually used.

As the belt layer 2, one or more sheets of a so-called spiral belt formed by spirally winding a long rubber-coated cord in which one reinforcing cord is covered with rubber or a belt ply with a plurality of reinforcing cords covered with rubber and having a cord direction substantially equal to the tire circumferential direction, or approximately 0° (3° or less) with respect to the tire circumferential direction can be used. As the reinforcing cord of the belt layer 2, in addition to a steel cord, a cord of a material of an organic fiber such as aromatic polyamide (aramid, for example, Kevlar (trade name) manufactured by DuPont), polyethylene naphthalate (PEN), polyethylene terephthalate (PET), rayon, zylon (registered trademark) (polyparaphenylene benzobisoxazole (PBO) fiber), or aliphatic polyamide (nylon), or glass fiber, carbon fiber, or the like can be appropriately selected and used. From the viewpoint of ensuring wear life and high speed durability at high levels, a steel cord is preferably used.

For example, as illustrated, a bead core 3 is embedded in each of a pair of bead portions 13 of the motorcycle tire of the present invention, and the carcass ply 1 is locked around the bead core 3 from the inside of the tire to the outside. Although not illustrated, an end of the carcass ply 1 may be locked by being sandwiched between bead wires from both sides. An inner liner (not illustrated) is formed on the innermost layer of the tire of the present invention.

The tire of the present invention is applicable as both a front tire and a rear tire of a motorcycle, and is particularly suitable as a rear tire, and can be applied to any tire having a radial structure or a bias structure.

### EXAMPLES

Hereinafter, the present invention will be described in more detail with reference to Examples.

### Example 1

A motorcycle tire of Example 1 having a sectional structure as shown in FIG. 1 at a tire size of 110/80R19MC and having a tread pattern as shown in FIG. 2 on a tire grounding portion was prepared.

A tread portion forming a tire grounding portion was composed of a central rubber located across the tire equator and a both-side rubber located on the outer side in the tire width direction, and a boundary between the central rubber and the both-side rubber was located at a position ⅝ of the half width of the peripheral length from the tire equator. The 300% modulus M₃₀₀(C) at 100° C. of a central rubber and the 300% modulus M₃₀₀(S) at 100° C. of a both-side rubber satisfied M₃₀₀(C)>M₃₀₀(S).

The bent portion of the first groove was located at a position ¼ of the half width of the peripheral length from the tire equator, the bent portion of the second groove was located at a position ⅜ of the half width of the peripheral length from the tire equator. the inner side end of the second groove in the tire width direction was located at a position ⅛ of the half width of the peripheral length from the tire equator, the outer side end of the second groove in the tire width direction was located at a position ¾ of the half width of the peripheral length from the tire equator, and the inner side end in the tire width direction of the third groove was located at a position 9/16 of the half width of the peripheral length from the tire equator.

Further, the acute angles θ1 and θ2 of the angles formed by the long groove portion and the short groove portion of the first groove with respect to the tire circumferential direction were 50 and 50° the acute angles θ3 and θ4 of the angles formed by the outer side groove portion and the inner side groove portion of the second groove with respect to the tire circumferential direction were 50° and 20°, and the acute angle θ5 of the angle formed by the third groove with respect to the tire circumferential direction was 50°). A distance a between the first groove and the second groove, a distance b between the second groove and the third groove, and a distance c between the third groove and the first groove in the tire circumferential direction measured between the open ends of the tire grounding portion were 25 mm, 25 mm, and 25 mm, respectively.

### Comparative Example 1

A motorcycle tire of Comparative Example 1 was prepared in the same manner as in Example 1 except that the entire tread portion forming the tire grounding portion was formed of the above-described central rubber.

Each of the obtained test tires was mounted on a rim having a rim size of MT2.50 19 inches, mounted as a front tire of a 1,000 cc-motorcycle, and filled to an internal pressure of 220 kPa. As the rear tire, a commercially available tire having a tire size of 150/70R17MC was used.

### (Wet Grip Performance During Turning)

For each of the test tires, a professional rider ran an actual vehicle on a test course on a wet road surface, and evaluated the grip performance during turning by feeling. The results are shown by an index with Comparative Example 1 being 100. The larger the numerical value, the more excellent the wet grip performance, which is favorable.

### (Steering Stability During Turning)

For each of the test tires, a professional rider ran an actual vehicle on a test course on a dry road surface, and evaluated the steering stability during turning by feeling. The results are shown by an index with Comparative Example 1 being 100. The larger the numerical value, the more excellent the steering stability, which is favorable.

The results are shown in the table below.

TABLE 1

| | | Comparative |
|---|---|---|
| | Example 1 | Example 1 |
| Wet grip performance during turning | 104 | 100 |
| (index) | | |
| Seeing stability during turning (index) | 108 | 100 |

As shown in the above table, it was confirmed that the tire of Example 1 obtained by arranging a central rubber and a both-side rubber having a relatively low modulus on a tread portion under predetermined conditions and arranging a first groove, a second groove, and a third groove under predetermined conditions was able to achieve both steering stability during turning and wet grip performance during turning.

### DESCRIPTION OF SYMBOLS

1 Carcass ply
2 Belt layer
3 Bead core
Tire
11 Tread portion
11C Central rubber
11S Both-side rubber
12 Sidewall portion
13 Bead portion
21 First groove
21A Long groove portion of first groove
21B Short groove portion of first groove
22 Second groove
22i inner side end in tire width direction of second groove
22o Outer side end in tire width direction of second groove
22A Outer side groove portion of second groove
22B Inner side groove portion of second groove
23 Third groove
23i Inner side end in tire width direction of third groove
31, 32 Shallow groove
c1, c2 Bent portion

1. A motorcycle tire comprising a directional pattern in which a rotation direction when mounted on a vehicle is specified on a tire grounding portion, wherein
a tread portion forming the tire grounding portion is composed of a central rubber arranged across a tire equator and a both-side rubber arranged outside the central rubber in a tire width direction and having a lower modulus than the central rubber, and a boundary between the central rubber and the both-side rubber is in a range of from ½ to ¾ of a half width of a peripheral length from the tire equator,
on the tire grounding portion, a first groove that comprises a bent portion and extends across the tire equator, and whose both ends in the tire width direction are open to tread ends, a second groove that comprises a bent portion and whose both ends in the tire width direction terminated in one side surface in the tire width direction, and a third groove whose outer side end in the tire width direction opens to the tread end and whose inner side end in the tire width direction terminates on one side surface in the tire width direction are sequentially provided in a direction opposite to a tire rotation direction,
the first groove extends in the tire rotation direction in an inclined manner so as to be substantially line-symmetric in the tire width direction about the bent portion, and the bent portion of the first groove is in a range of from ⅛ to ⅜ of the half width of the peripheral length from the tire equator,
the bent portion of the second groove is in a range of from ¼ to ½ of the half width of the peripheral length from the tire equator, the inner side end in the tire width direction of the second groove is in a range of from 1/16 to 3/16 of the half width of the peripheral length from the tire equator, and the outer side end in the tire width direction of the second groove is in a range of from ⅝ to ⅞ of the half width of the peripheral length from the tire equator,
the inner side end in the tire width direction of the third groove is in a range of from ½ to ⅝ of the half width of the peripheral length from the tire equator,
when two groove portions extending in an inclined manner so as to be line-symmetric in the tire width direction of the first groove are defined as a long groove portion extending across the tire equator and a short groove portion extending in one side surface in the tire width direction, and acute angles of angles formed by the long groove portion and the short groove portion with respect to the tire circumferential direction are defined as θ1 and θ2, respectively, when, with the bent portion interposed, a groove portion on the outer side in the tire width direction of the second groove is defined as an outer side groove portion and a groove portion on the inner side in the tire width direction of the second groove is defined as an inner side groove portion, and acute angles of angles formed by the outer side groove portion and the inner side groove portion with respect to the tire circumferential direction are defined as θ3 and θ4, respectively, and when an acute angle of angles formed by the third groove with respect to the tire circumferential direction is defined as θ5, θ1≈θ2≈θ3≈θ5, and θ1>θ4 are satisfied, and,
distances a, b, and c between the grooves in the tire circumferential direction measured between the open ends of the tire grounding portions of the first groove and the second groove, the second groove and the third groove, and the third groove and the first groove satisfy a≈b≈c.

2. The motorcycle tire according to claim 1, wherein the angle θ1 of the long groove portion of the first groove is in a range of from 45° to 55°, and the angle θ2 of the short groove portion of the first groove is in a range of from 45° to 55°.

3. The motorcycle tire according to claim 1, wherein the angle θ3 of the outer side groove portion of the second groove is in a range of from 45° to 55°, and the angle θ4 of the inner side groove portion of the second groove is in a range of from 15° to 25°.

4. The motorcycle tire according to claim 1, wherein the angle θ5 of the third groove is in a range of from 45° to 55°.

5. The motorcycle tire according to claim 1, wherein a shallow groove is arranged near the third groove.

6. The motorcycle tire according to claim 2, wherein the angle θ3 of the outer side groove portion of the second groove is in a range of from 45° to 55°, and the angle θ4 of the inner side groove portion of the second groove is in a range of from 15° to 25°.

7. The motorcycle tire according to claim 2, wherein the angle 65 of the third groove is in a range of from 45° to 55°.

8. The motorcycle tire according to claim 2, wherein a shallow groove is arranged near the third groove.

9. The motorcycle tire according to claim 3, wherein the angle 65 of the third groove is in a range of from 45° to 55°.

10. The motorcycle tire according to claim 3, wherein a shallow groove is arranged near the third groove.

11. The motorcycle tire according to claim 4, wherein a shallow groove is arranged near the third groove.
